(19) United States
(12) Patent Application Publication
(10) Pub. No.: US 2023/0078780 A1
(43) Pub. Date: Mar. 16, 2023

(54) SADDLE-RIDE TYPE VEHICLE

(71) Applicant: HONDA MOTOR CO., LTD., Tokyo (JP)

(72) Inventors: Kei Mayuzumi, Tokyo (JP); Keita Mikura, Tokyo (JP); Kazuya Sawasaki, Tokyo (JP); Kazuyuki Tachibana, Tokyo (JP); Yuki Kanemura, Tokyo (JP)

(21) Appl. No.: 17/800,267

(22) PCT Filed: Dec. 23, 2020
(86) PCT No.: PCT/JP2020/048285

§ 371 Date: Aug. 17, 2022

(30) Foreign Application Priority Data
Feb. 21, 2020 (JP) 2020-028111

(51) Int. Cl. B62K 11/04; B62K 19/24; B62K 19/40

(52) U.S. Cl. CPC B62K 11/04; B62K 19/24; B62K 19/40

(57) ABSTRACT

A saddle-ride type vehicle in which a rear frame and a rear suspension can be attached to a vehicle body frame with a small number of parts and with a simple structure. The saddle-ride type vehicle includes a rear frame fastened to a frame portion of a rear portion of a vehicle body frame, and a rear suspension disposed at a rear portion of the vehicle body frame. The vehicle body frame includes a tubular member inserted into the frame portion in a vehicle width direction and fixed to the frame portion. The rear frame is fastened by a frame fastener to a frame fixation portion provided at an inner end portion of the tubular member in the vehicle width direction, and the rear suspension is connected to a suspension connecting portion provided at an outer end portion of the tubular member in the vehicle width direction.

### TECHNICAL FIELD

The present invention relates to saddle-ride type vehicles.

### BACKGROUND ART

There has been known a saddle-ride type vehicle including a rear frame fastened to a rear portion of the vehicle body frame and a rear suspension disposed at a rear portion of the vehicle body frame (for example, see Patent Literature 1). In Patent Literature 1, the rear suspension is attached to a cross member located at an upper end portion of the vehicle body frame, and the rear frame is fastened below the cross member to the vehicle body frame.

### CITATION LIST

### Patent Literature

[Patent Literature 1]
Japanese Patent Laid-Open No. 2000-280964

### SUMMARY OF INVENTION

### Technical Problem

Saddle-ride type vehicles are desired to have a rear frame and a rear suspension that can be attached to the vehicle body frame with a simple structure.

The present invention has been made in light of the above situation, and an object thereof is to provide a saddle-ride type vehicle in which a rear frame and a rear suspension can be attached to a vehicle body frame with a small number of parts and with a simple structure.

### Solution to Problem

This specification includes the entire contents of Japanese Patent Application No. 2020-028111, filed on Feb. 21, 2020.

A saddle-ride type vehicle includes: a rear frame (20) fastened to a frame portion (19) that is a rear portion of a vehicle body frame (10); and a rear suspension (32) disposed at a rear portion of the vehicle body frame (10), wherein the vehicle body frame (10) includes a tubular member (55) inserted into the frame portion (19) in a vehicle width direction and fixed to the frame portion (19), the rear frame (20) is fastened by a frame fastener (58) to a frame fixation portion (75) provided at an inner end portion of the tubular member (55) in the vehicle width direction, and the rear suspension (32) is connected to a suspension connecting portion (73) provided at an outer end portion of the tubular member (55) in the vehicle width direction.

In the above configuration, the frame fixation portion (75) and the suspension connecting portion (73) may be coaxial.

In the above configuration, the rear frame (20) may include a connection portion (20a) that overlaps with the frame portion (19) from the inside in the vehicle width direction, and the connection portion (20a) may be fastened to the frame fixation portion (75) by the frame fastener (58) inserted into the connection portion (20a) from the inside in the vehicle width direction.

In the above configuration, the connection portion (20a) may be fastened to the frame portion (19) at a position different from the position of the frame fastener (58) by a fastener (59) inserted into the connection portion (20a) from the inside in the vehicle width direction.

In the above configuration, the rear suspension (32) may fit to an outer peripheral portion (73c) of the suspension connecting portion (73) and be prevented from coming out in the vehicle width direction by a suspension fixing member (76) fastened to the suspension connecting portion (73) from the outside in the vehicle width direction.

In the above configuration, the frame portion (19) may include a tubular-member fixing hole (68) passing through the frame portion (19) in the vehicle width direction, the tubular member (55) may include an outer fitting portion (71) that fits into the tubular-member fixing hole (68) and an inner fitting portion (72) that fits into the tubular-member fixing hole (68) at a position on the inside of the outer fitting portion (71) in the vehicle width direction, an outer diameter of the outer fitting portion (71) may be larger than an outer diameter of the inner fitting portion (72), and the suspension connecting portion (73) may extend outward in the vehicle width direction from the outer fitting portion (71).

In the above configuration, the frame portion (19) may include an outer side wall (65) that faces the rear suspension (32) and an inner side wall (66) that is away inward in the vehicle width direction from the outer side wall (65) and be formed to be hollow, and the outer fitting portion (71) may fit into the tubular-member fixing hole (68) of the outer side wall (65), and the inner fitting portion (72) may fit into the tubular-member fixing hole (68) of the inner side wall (66).

In the above configuration, the frame fastener (58) may be inserted into the rear frame (20) from the inside in the vehicle width direction, the rear suspension (32) may fit to an outer peripheral portion (73c) of the suspension connecting portion (73) and be prevented from coming out in the vehicle width direction by a suspension fixing member (76) fastened to the suspension connecting portion (73) from the outside in the vehicle width direction, the frame portion (19) may include a tubular-member fixing hole (68) passing through the frame portion (19) in the vehicle width direction, the tubular member (55) may include an outer fitting portion (71) that fits into the tubular-member fixing hole (68) and an inner fitting portion (72) that fits into the tubular-member fixing hole (72) at a position on the inside of the outer fitting portion (71) in the vehicle width direction, an outer diameter of the outer fitting portion (71) may be larger than an outer diameter of the inner fitting portion (72), the suspension connecting portion (73) may extend outward in the vehicle width direction from the outer fitting portion (71), an inner end portion (76c) of the suspension fixing member (76) in the vehicle width direction may be located on the outside of the outer fitting portion (71) in the vehicle width direction, and an outer end portion (58a) in the vehicle width direction of the frame fastener (58) fastened to the frame fixation portion (75) may be located inside the tubular-member fixing hole (68).

### Advantageous Effects of Invention

A saddle-ride type vehicle includes: a rear frame fastened to a frame portion that is a rear portion of a vehicle body frame; and a rear suspension disposed at a rear portion of the vehicle body frame, wherein the vehicle body frame includes a tubular member inserted into the frame portion in a vehicle width direction and fixed to the frame portion, the rear frame is fastened by a frame fastener to a frame fixation portion provided at an inner end portion of the tubular member in the vehicle width direction, and the rear suspension is connected to a suspension connecting portion provided at an outer end portion of the tubular member in the vehicle width direction.

With this configuration, since both the rear suspension and the rear frame are attached to the tubular member inserted into the frame portion of the vehicle body frame in the vehicle width direction, it is possible to attach the rear frame and the rear suspension to the vehicle body frame with a small number of parts and with a simple structure.

In the above configuration, the frame fixation portion and the suspension connecting portion may be coaxial.

With this configuration, since the frame fixation portion and the suspension connecting portion are coaxial, it is easy to produce the tubular member.

In the above configuration, the rear frame may include a connection portion that overlaps with the frame portion from the inside in the vehicle width direction, and the connection portion may be fastened to the frame fixation portion by the frame fastener inserted into the connection portion from the inside in the vehicle width direction.

With this configuration, since the connection portion of the rear frame and the frame fastener can be hidden by the frame portion from the outside in the vehicle width direction, it is possible to make the outer appearance simple and improve the outer appearance.

In the above configuration, the connection portion may be fastened to the frame portion at a position different from the position of the frame fastener by a fastener inserted into the connection portion from the inside in the vehicle width direction.

With this configuration, it is possible to firmly fix the rear frame by using the fastener and to make the fastener less conspicuous.

In the above configuration, the rear suspension may fit to an outer peripheral portion of the suspension connecting portion and be prevented from coming out in the vehicle width direction by a suspension fixing member fastened to the suspension connecting portion from the outside in the vehicle width direction.

With this configuration, it is possible to prevent the rear suspension from coming out with a simple structure. In addition, since this configuration has the suspension fixing member and the frame fastener separately, it is possible to attach and detach the rear suspension and the rear frame individually.

In the above configuration, the frame portion may include a tubular-member fixing hole passing through the frame portion in the vehicle width direction, the tubular member may include an outer fitting portion that fits into the tubular-member fixing hole and an inner fitting portion that fits into the tubular-member fixing hole at a position on the inside of the outer fitting portion in the vehicle width direction, an outer diameter of the outer fitting portion may be larger than an outer diameter of the inner fitting portion, and the suspension connecting portion may extend outward in the vehicle width direction from the outer fitting portion.

With this configuration, since as for the tubular member, the outer diameter of the outer fitting portion provided on the rear suspension side is larger than the outer diameter of the inner fitting portion, it is possible to receive the load of the rear suspension efficiently via the outer fitting portion.

In the above configuration, the frame portion may include an outer side wall that faces the rear suspension and an inner side wall that is away inward in the vehicle width direction from the outer side wall and be formed to be hollow, and the outer fitting portion may fit into the tubular-member fixing hole of the outer side wall, and the inner fitting portion may fit into the tubular-member fixing hole of the inner side wall.

With this configuration, it is possible to reduce the weight by making the frame portion hollow. In addition, it is possible to support the tubular member effectively with the outer side wall and the inner side wall.

In the above configuration, the frame fastener may be inserted into the rear frame from the inside in the vehicle width direction, the rear suspension may fit to an outer peripheral portion of the suspension connecting portion and be prevented from coming out in the vehicle width direction by a suspension fixing member fastened to the suspension connecting portion from the outside in the vehicle width direction, the frame portion may include a tubular-member fixing hole passing through the frame portion in the vehicle width direction, the tubular member may include an outer fitting portion that fits into the tubular-member fixing hole and an inner fitting portion that fits into the tubular-member fixing hole at a position on the inside of the outer fitting portion in the vehicle width direction, an outer diameter of the outer fitting portion may be larger than an outer diameter of the inner fitting portion, the suspension connecting portion may extend outward in the vehicle width direction from the outer fitting portion, an inner end portion of the suspension fixing member in the vehicle width direction may be located on the outside of the outer fitting portion in the vehicle width direction, and an outer end portion in the vehicle width direction of the frame fastener fastened to the frame fixation portion may be located inside the tubular-member fixing hole.

With this configuration, since the outer end portion of the frame fastener in the vehicle width direction gets into the inside of the tubular-member fixing hole, the portion located inside the tubular-member fixing hole in the frame fixation portion of the tubular member is solid because it is filled with the frame fastener. Thus, even in the case in which the outer diameter of the inner fitting portion is small, it is possible to achieve enough stiffness of the inner fitting portion.

In addition, the inner end portion of the suspension fixing member in the vehicle width direction is located on the outside of the outer fitting portion in the vehicle width direction, and the suspension fixing member is relatively short. Thus, it is possible to reduce the weight of the suspension fixing member. In addition, since the outer fitting portion has a larger diameter than the inner fitting portion, it is possible to achieve enough stiffness of the outer fitting portion.

### BRIEF DESCRIPTION OF DRAWINGS

FIG. 1 is a left side view of a motorcycle according to an embodiment of the present invention.

FIG. 2 is a perspective view of rear frames fastened to a seat frame, seen from the left side.

FIG. 3 is a perspective view of a rear portion of a left portion of the seat frame, seen from the inside in the vehicle width direction.

FIG. 4 is a perspective view of the left rear frame fastened to the seat frame, seen from the inside in the vehicle width direction.

FIG. 5 is a cross-sectional view taken along line V-V in FIG. 1.

### DESCRIPTION OF EMBODIMENTS

Hereinafter, an embodiment of the present invention will be described with reference to the drawings. Note that the directions mentioned in the description such as front-rear, right-left, and upper-lower are the same as the directions with respect to the vehicle body, unless otherwise specified. In each drawing, the symbol FR indicates the front direction relative to the vehicle body, the symbol UP indicates the upward direction relative to the vehicle body, and the symbol LH indicates the left direction relative to the vehicle body.

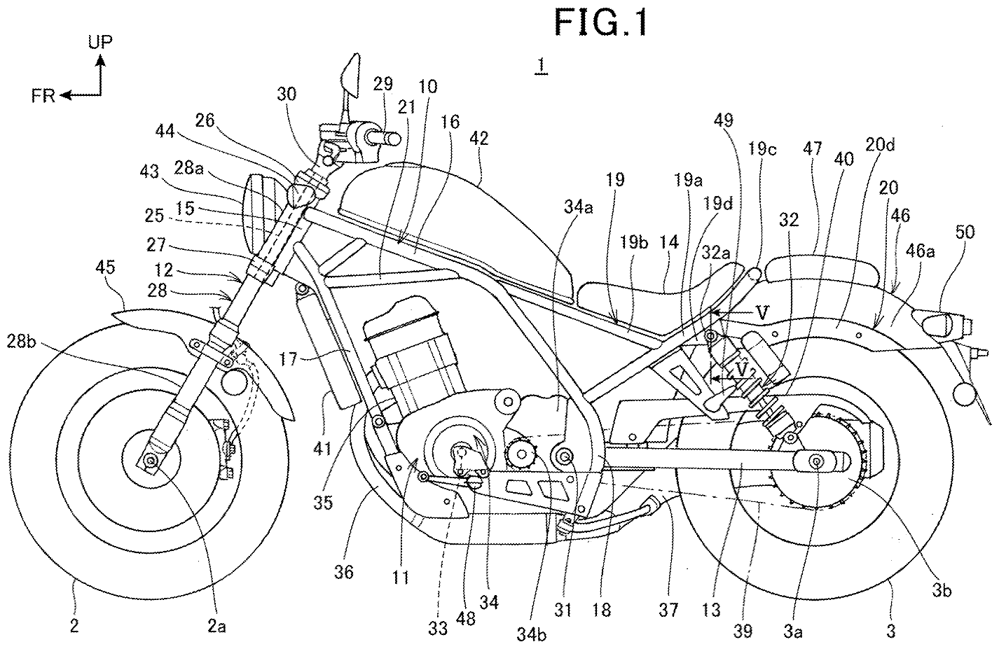

FIG. 1 is a left side view of a motorcycle 1 according to the embodiment of the present invention.

The motorcycle 1 is a vehicle in which an engine 11 serving as a power unit is supported by a vehicle body frame 10, a front fork 12 that steerably supports a front wheel 2 is steerably supported by the front end of the vehicle body frame 10, and a swing arm 13 supporting a rear wheel 3 is provided at the rear side of the vehicle body frame 10.

The motorcycle 1 is a saddle-ride type vehicle which the occupant (driver) sits astride, sitting on a seat 14, and the seat 14 is provided above a rear portion of the vehicle body frame 10.

The vehicle body frame 10 includes a head pipe 15 provided at the front end of the vehicle body frame 10, a pair of right and left main frames 16 extending rearward and downward from the head pipe 15, a pair of right and left down frames 17 extending rearward and downward from a portion of the head pipe 15 on the lower side of the main frames 16, a pair of right and left pivot frames 18 extending downward from the rear end of the main frames 16, a seat frame 19 (frame portion) extending rearward from rear portions of the main frames 16 and upper portions of the pivot frames 18, and rear frames 20 extending from rear portions of the seat frame 19 to a rear end portion of the motorcycle 1.

In addition, the vehicle body frame 10 includes a pair of right and left reinforcement frames 21 connecting upper portions of the down frames 17 and upper portions of the main frames 16.

The seat frame 19 is a frame portion located at a rear portion of the vehicle body frame 10.

Specifically, the seat frame 19 includes a pair of right and left lower seat rails 19a extending rearward and upward from the right and left pivot frames 18, a pair of right and left upper seat rails 19b extending rearward and downward from the rear end portions of the right and left main frames 16 and then connected to intermediate portions in the front-rear direction of the lower seat rails 19a, and a right-left connection portion 19c connecting the rear ends of the right and left lower seat rails 19a in the vehicle width direction (right-left direction).

The rear frames 20 extend rearward from rear portions of the lower seat rails 19a.

The front fork 12 includes a steering shaft 25 rotatably supported by the head pipe 15, a top bridge 26 fixed at the upper end of the steering shaft 25, a bottom bridge 27 fixed at the lower end of the steering shaft 25, and a pair of right and left fork tubes 28 supported by the top bridge 26 and the bottom bridge 27.

The fork tubes 28 are telescopic suspensions. The fork tubes 28 include fixed tubes 28a fixed to the top bridge 26 and the bottom bridge 27 and movable tubes 28b fitted into the lower portions of the respective fixed tubes 28a and capable of axially reciprocating relative to the fixed tubes 28a.

The top bridge 26 extends from the steering shaft 25 in the vehicle width direction above the head pipe 15 and connects upper end portions of the right and left fixed tubes 28a.

The bottom bridge 27 extends from the steering shaft 25 in the vehicle width direction below the head pipe 15 and connects the right and left fixed tubes 28a.

The fork tubes 28 are disposed so as to be inclined rearward in vehicle side view. The front wheel 2 is rotatably supported by an axle 2a disposed between lower end portions of the right and left movable tubes 28b and is located between the right and left movable tubes 28b.

The handle 29 for the occupant to steer the front fork 12 to the right and left is attached to the top bridge 26 via a handle post 30.

The swing arm 13 is pivotally supported by a pivot shaft 31 supported by the right and left pivot frames 18. The pivot shaft 31 extends horizontally in the vehicle width direction. A front end portion of the swing arm 13 is pivotally supported by the pivot shaft 31 and swings up and down around the pivot shaft 31.

The rear wheel 3 is rotatably supported by an axle 3a provided at a rear end portion of the swing arm 13.

The motorcycle 1 includes a pair of right and left rear suspensions 32 disposed between rear end portions of the swing arm 13 and the seat frame 19.

The engine 11 is disposed below the main frames 16 and between the down frames 17 and the pivot frames 18 in the vehicle front-rear direction and fixed to the vehicle body frame 10.

The engine 11 includes a crank case 34 supporting a crank shaft 33 extending horizontally in the vehicle width direction (right-left direction) and a cylinder portion 35 storing a piston (not illustrated) that reciprocates. The cylinder portion 35 extends upward from the upper face of a front portion of the crank case 34.

An exhaust device of the engine 11 includes an exhaust pipe 36 connected to an exhaust port in the front face of the cylinder portion 35 and a muffler 37 connected to the downstream end of the exhaust pipe 36.

The rear portion of the crank case 34 is a transmission case portion 34a storing a transmission. An output shaft (not illustrated) of the transmission protrudes outward in the vehicle width direction from the transmission case portion 34a, and the output shaft is provided with a drive sprocket 34b.

The output of the engine 11 is transmitted to the rear wheel 3 through a drive-power transmission member 39 connecting the drive sprocket 34b and a driven sprocket 3b of the rear wheel 3. In this case, the drive-power transmission member 39 is an endless chain disposed between the drive sprocket 34b and the driven sprocket 3b so as to be wound on them, but the drive-power transmission member 39 may be, for example, an endless belt.

A cover member 40 covering the drive-power transmission member 39 is attached to the swing arm 13.

A radiator 41 through which cooling water for the engine 11 passes is disposed below the head pipe 15 and on the front side of the engine 11.

A fuel tank 42 is disposed above the main frames 16 and between the head pipe 15 and the seat 14.

A head light 43 is provided on the front side of the head pipe 15. Turn signals 44 are attached to upper portion of the fork tubes 28.

The front fender 45 which covers the front wheel 2 from above is supported by the fork tube 28.

A rear fender 46 that covers the rear wheel 3 from above is supported by the rear frames 20. The rear fender 46 is disposed on the rear side of the seat 14.

The motorcycle 1 includes a rear seat 47 on which a passenger sits, on the rear side of the seat 14. The rear seat 47 is disposed on the upper surface of the rear fender 46.

A pair of right and left steps 48 on which the occupant sitting on the seat 14 puts his/her feet are disposed on the front side of the right and left pivot frames 18. Pillion steps 49 on which the passenger sitting on the rear seat 47 puts his/her feet are disposed on the front lower side of the rear seat 47.

A tail-light unit 50 is attached to a rear end portion of the rear fender 46.

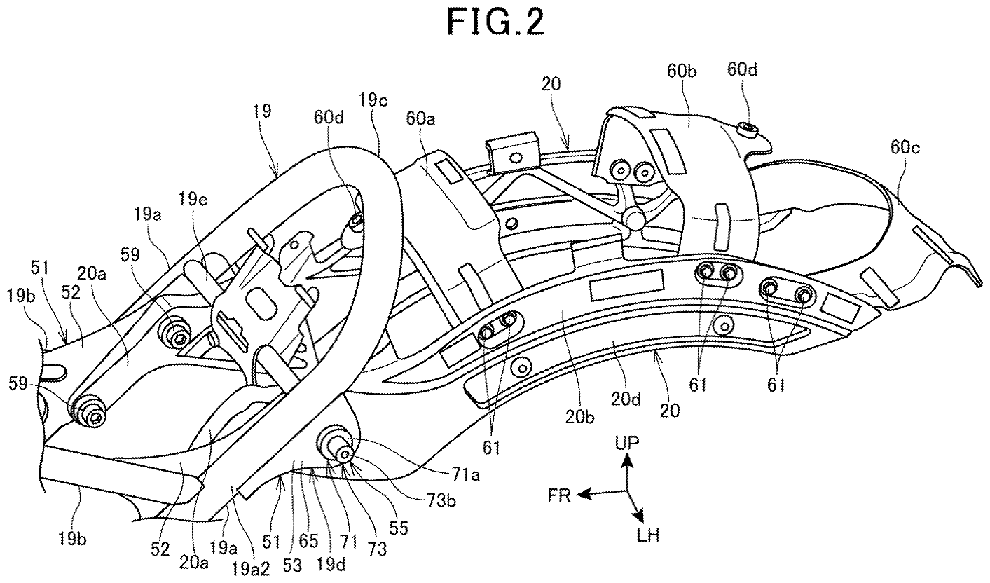

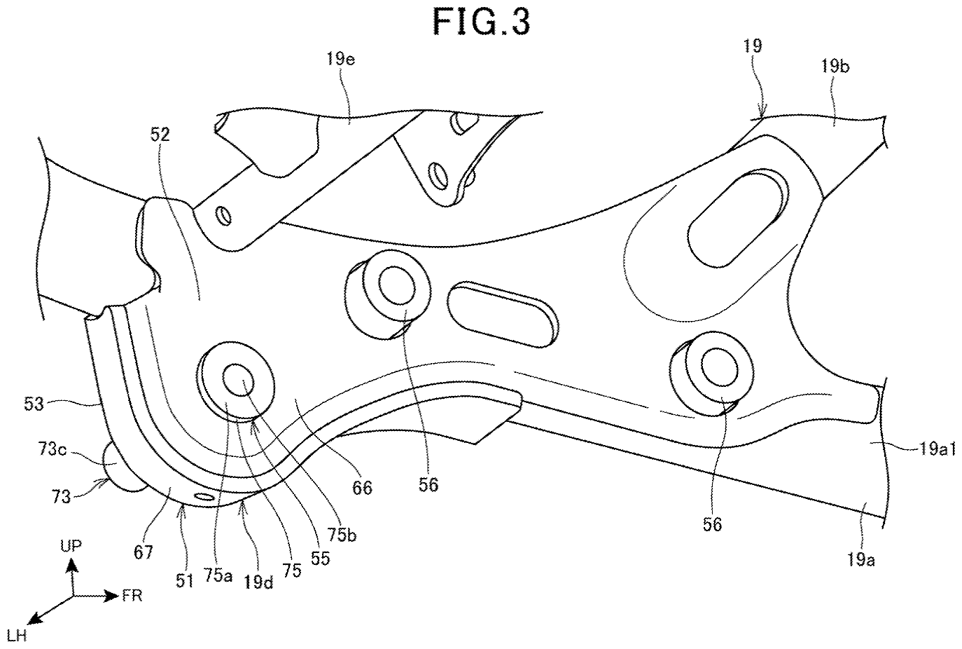

FIG. 2 is a perspective view of rear frames 20 fastened to the seat frame 19, seen from the left side. FIG. 3 is a perspective view of a rear portion of a left portion of the seat frame 19, seen from the inside in the vehicle width direction.

With reference to FIGS. 2 and 3, a rear portion of each lower seat rail 19a is provided with a reinforcement member 51.

The reinforcement member 51 includes an inner reinforcement plate 52 attached to the inside face 19a1 of the lower seat rail 19a in the vehicle width direction and an outer reinforcement plate 53 attached to the outside face 19a2 of the lower seat rail 19a in the vehicle width direction.

The inner reinforcement plate 52 is provided to extend over the lower seat rail 19a and the connection portion between the lower seat rail 19a and the upper seat rail 19b. A rear portion of the inner reinforcement plate 52 extends downward relative to the lower seat rail 19a.

The outer reinforcement plate 53 is fixed to a rear portion of the outside face 19a2 of the lower seat rail 19a and extends downward relative to the lower seat rail 19a.

The reinforcement member 51 includes a stay portion 19d formed of a rear portion of the inner reinforcement plate 52 and the outer reinforcement plate 53 overlapped with and connected with each other in the vehicle width direction below the lower seat rail 19a. In other words, the seat frame 19 includes the stay portions 19d extending downward from the lower faces of rear portions of the pipe-shaped lower seat rails 19a. The stay portion 19d is provided to each of the right and left lower seat rails 19a.

The seat frame 19 includes a reinforcement frame portion 19e connecting the right and left lower seat rails 19a in the vehicle width direction at positions near the stay portions 19d. The reinforcement frame portion 19e is located below the right-left connection portion 19c.

The seat frame 19 includes tubular members 55 fixed to the respective stay portions 19d in a state in which the tubular member 55 is inserted into the stay portion 19d in the vehicle width direction.

In addition, the seat frame 19 includes a plurality of fastening portions 56 on the inside face 19a1 of the lower seat rail 19a.

The fastening portion 56 is a tubular portion extending from the inside face 19a1, passing through the inner reinforcement plate 52, and protruding inward in the vehicle width direction. Note that the fastening portions 56 may be welded to the inner reinforcement plate 52.

The fastening portions 56 are provided in a pair at positions on the front side of the tubular member 55.

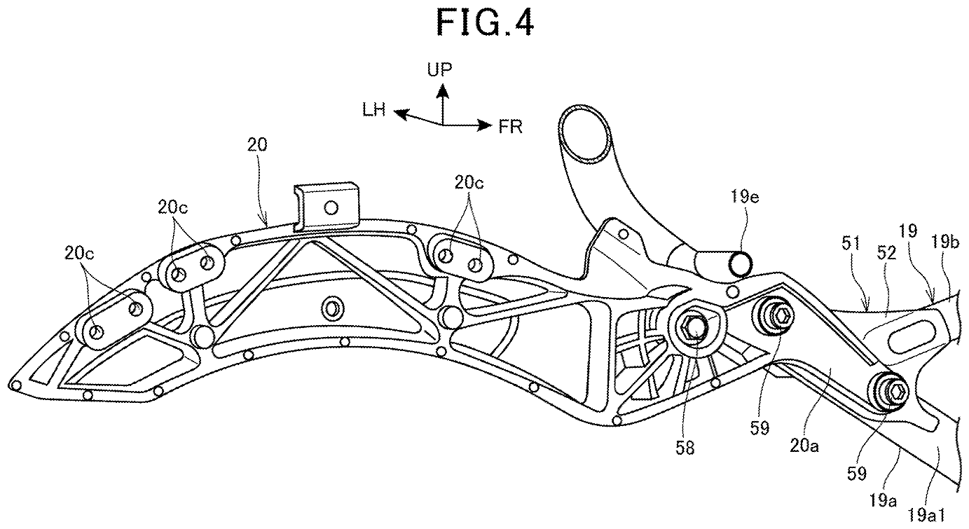

FIG. 4 is a perspective view of the left rear frame 20 fastened to the seat frame 19, seen from the inside in the vehicle width direction. The structures of the connection portions between the seat frame 19 and the rear frames 20 are approximately bilaterally symmetrical, and hence, description will be mainly made here with reference to the left rear frame 20.

With reference to FIGS. 2 and 4, the rear frames 20 are provided in a pair on the right and left sides and are respectively connected to the right and left lower seat rails 19a. The rear frame 20 is also connected to the stay portion 19d.

The rear frame 20 is a long plate-shaped member extending in the vehicle front-rear direction and is oriented such that the thickness direction is aligned with the vehicle width direction.

The front end portion of the rear frame 20 is a connection portion 20a that overlaps with a rear portion of the seat frame 19 from the inside in the vehicle width direction.

The rear frame 20 is fastened to the tubular member 55 of the stay portion 19d by a frame fastener 58 inserted into the connection portion 20a from the inside in the vehicle width direction.

The rear frame 20 is fastened to the fastening portions 56 (FIG. 3) of the lower seat rail 19a by fasteners 59 inserted into the connection portion 20a from the inside in the vehicle width direction. The fasteners 59 are located on the front side of the frame fastener 58.

With reference to FIG. 2, the right and left rear frames 20 are connected in the vehicle width direction by a first brace 60a provided on the rear side of the connection portion 20a, a second brace 60b provided on the rear side of the first brace 60a, and a third brace 60c provided on the rear side of the second brace 60b.

The first brace 60a, the second brace 60b, and the third brace 60c have arch shapes, and the right and left lower end portions of the arch shapes are respectively fastened to the right and left rear frames 20. The upper surface of the first brace 60a and the upper surface of the second brace 60b are each provided with a rear-fender fastening portion 60d.

The rear fender 46 (FIG. 1) is placed on the first brace 60a, the second brace 60b, and the third brace 60c from above. The rear fender 46 is fixed to the first brace 60a and the second brace 60b by rear-fender fixing members (not illustrated) that are inserted into the rear fender 46 from above and fastened to the rear-fender fastening portions 60d.

In vehicle side view, the outside face of an upper portion of the rear frame 20 has a step portion 20b (FIG. 2) that is recessed inward in the vehicle width direction relative to the outside face 20d (FIG. 2) of a lower portion of the rear frame 20. The step portion 20b is continuous from a front portion to the rear end of the rear frame 20.

The step portion 20b has a plurality of brace fixing holes 20c. The first brace 60a, the second brace 60b, and the third brace 60c are fastened to the inside faces of the rear frames 20 in the vehicle width direction by brace fasteners 61 inserted into the brace fixing holes 20c from the outside in the vehicle width direction.

With reference to FIGS. 1 and 2, right and left lower edge portions 46a of the rear fender 46 fit into the step portions 20b of the rear frames 20. With this configuration, the outside face 20d of the lower portion of the rear frame 20 and the lower edge portion 46a of the rear fender 46 are approximately flush, making the outer appearance favorable. The brace fasteners 61 are hidden by being covered with the lower edge portion 46a of the rear fender 46.

The upper face of the rear fender 46 supports the rear seat 47.

The rear frames 20 receive the load that acts on the rear seat 47 via the rear fender 46, the first brace 60a, the second brace 60b, and the third brace 60c.

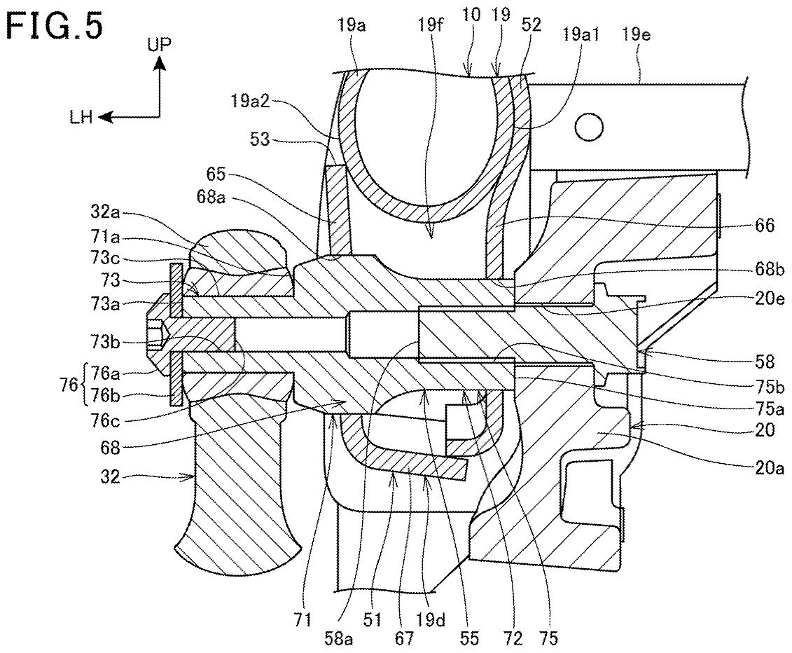

FIG. 5 is a cross-sectional view taken along line V-V in FIG. 1.

The stay portion 19d of the seat frame 19 includes an outer side wall 65 that is the outer side wall of the stay portion 19d in the vehicle width direction, an inner side wall 66 that is away inward in the vehicle width direction from the outer side wall 65, and a lower wall 67 that connects the lower end of the outer side wall 65 and the lower end of the inner side wall 66 in the vehicle width direction. The outer side wall 65 faces the rear suspension 32 from the inside in the vehicle width direction.

The stay portion 19d is hollow, and formed inside of the stay portion 19d is a space 19f surrounded by the outer side wall 65, the inner side wall 66, the lower wall 67, and the lower face portion of the lower seat rail 19a.

The outer side wall 65 and the lower wall 67 are formed by the outer reinforcement plate 53. The inner side wall 66 is formed by the inner reinforcement plate 52.

The stay portion 19d has a tubular-member fixing hole 68 having a circular shape and passing through the stay portion 19d in the vehicle width direction.

Specifically, the tubular-member fixing hole 68 includes an outer fixing hole 68a passing through the outer side wall 65 and an inner fixing hole 68b passing through the inner side wall 66. The inner diameter of the outer fixing hole 68a is larger than the inner diameter of the inner fixing hole 68b.

The tubular member 55 has a long tubular shape extending in the vehicle width direction.

The tubular member 55 is inserted into the tubular-member fixing hole 68 in the vehicle width direction and fixed to the tubular-member fixing hole 68.

The tubular member 55 integrally includes an outer fitting portion 71 that fits into the outer fixing hole 68a of the tubular-member fixing hole 68, an inner fitting portion 72 that fits into the inner fixing hole 68b of the tubular-member fixing hole 68, and a suspension connecting portion 73 extending outward in the vehicle width direction from the outer fitting portion 71.

The outer fitting portion 71 has a tubular shape, and its outer peripheral portion is fixed to the outer fixing hole 68a by welding. The outer diameter of the outer fitting portion 71 is larger than the outer diameter of the inner fitting portion 72.

The outside face 71a of the outer fitting portion 71 in the vehicle width direction protrudes outward in the vehicle width direction from the outer side wall 65.

The inner fitting portion 72 has a tubular shape, and its outer peripheral portion is fixed to the inner fixing hole 68b by welding.

The outer diameter of the inner fitting portion 72 is smaller than the outer diameter of the outer fitting portion 71, and the boundary between the outer fitting portion 71 and the inner fitting portion 72 is located in the space 19f.

The inner fitting portion 72 is a frame fixation portion 75 provided at an inner end portion of the tubular member 55 in the vehicle width direction.

The inner end face 75a of the frame fixation portion 75 in the vehicle width direction protrudes inward in the vehicle width direction from the inner side wall 66.

In the center of the frame fixation portion 75 is provided an inner threaded hole portion 75b extending in the axial direction of the tubular member 55 (in the vehicle width direction). The inner threaded hole portion 75b extends from the end face 75a to the inside of the outer fitting portion 71.

The suspension connecting portion 73 is provided at an outer end portion of the tubular member 55 in the vehicle width direction.

The suspension connecting portion 73 has a tubular shape and extends outward in the vehicle width direction from the outside face 71a of the outer fitting portion 71 in the vehicle width direction. The outer end face 73a of the suspension connecting portion 73 in the vehicle width direction is a flat face orthogonal to the axial direction of the tubular member 55.

The outer diameter of the suspension connecting portion 73 is smaller than the outer diameter of the outer fitting portion 71 and the outer diameter of the inner fitting portion 72.

In the center of the suspension connecting portion 73 is provided an outer threaded hole portion 73b extending in the axial direction of the tubular member 55. The outer threaded hole portion 73b has a smaller diameter than the inner threaded hole portion 75b.

The outer threaded hole portion 73b extends from the end face 73a to the inside of the outer fitting portion 71 and communicates with the inner threaded hole portion 75b. In other words, the outer threaded hole portion 73b and the inner threaded hole portion 75b are a hole axially passing through the tubular member 55.

The suspension connecting portion 73, the outer fitting portion 71, and the frame fixation portion 75 (inner fitting portion 72) have tubular shapes coaxial with one another. Hence, in the case of producing the tubular member 55, for example, by machine work, it is easy to produce.

Note that the outer threaded hole portion 73b and the inner threaded hole portion 75b do not have to communicate with each other, and the tubular member 55 may have a portion that is not tubular.

The connection portion 20a of the rear frame 20 has a fixation hole 20e passing through the connection portion 20a in the vehicle width direction.

The connection portion 20a is fixed to the end face 75a of the frame fixation portion 75 by the frame fastener 58 inserted into the fixation hole 20e from the inside in the vehicle width direction and fastened to the inner threaded hole portion 75b.

In other words, the rear frame 20 is fastened to the tubular member 55 by the frame fastener 58.

The outer end portion 58a of the frame fastener 58 in the vehicle width direction gets into the inside of the tubular-member fixing hole 68 and is located inside the space 19f.

An upper end portion 32a of the rear suspension 32 is connected to the suspension connecting portion 73. The lower end portion of the rear suspension 32 is connected to a rear end portion of the swing arm 13 (FIG.

The upper end portion 32a fits to the outer peripheral portion 73c of the suspension connecting portion 73. The upper end portion 32a is swingable forward and back with the outer peripheral portion 73c as the center.

A suspension fixing member 76 is attached to the end face 73a of the suspension connecting portion 73. The suspension fixing member 76 includes a bolt 76a that is fastened to the outer threaded hole portion 73b from the outside in the vehicle width direction and a washer 76b that is provided between the bolt 76a and the end face 73a.

The upper end portion 32a of the rear suspension 32, around the outer peripheral portion 73c, is sandwiched between the washer 76b and the outside face 71a of the outer fitting portion 71 and thus positioned in the vehicle width direction. The upper end portion 32a is prevented from coming out in the vehicle width direction by the suspension fixing member 76.

The inner end portion 76c of the bolt 76a in the vehicle width direction is located inside the suspension connecting portion 73. Specifically, the end portion 76c is located on the outside of the outer fitting portion 71 in the vehicle width direction and does not extend into the inside of the tubular-member fixing hole 68. The bolt 76a is only for preventing the upper end portion 32a from coming out and hence can be relatively short.

The upper end portion 32a of the rear suspension 32 is connected to the outer end portion in the vehicle width direction of the tubular member 55 of the seat frame 19, the rear frame 20 is fixed to the inner end portion of the tubular member 55 in the vehicle width direction, and the rear suspension 32 and the rear frame 20 both are attached to the tubular member 55. Thus, the rear suspension 32 and the rear frame 20 can be attached to the seat frame 19 with a simple structure.

Since the rear frame 20 and the upper end portion 32a of the rear suspension 32 are directly connected via the tubular member 55, the load that acts on the rear frame 20 can be transmitted efficiently to the rear suspension 32 via the tubular member 55.

As has been described above, a motorcycle 1 according to an embodiment to which the present invention is applied includes: a rear frame 20 fastened to a seat frame 19 which is a frame portion of a rear portion of a vehicle body frame 10; and a rear suspension 32 disposed at a rear portion of the vehicle body frame 10, wherein the vehicle body frame 10 includes a tubular member 55 inserted into the seat frame 19 in a vehicle width direction and fixed to the seat frame 19, the rear frame 20 is fastened by a frame fastener 58 to a frame fixation portion 75 provided at an inner end portion of the tubular member 55 in the vehicle width direction, and the rear suspension 32 is connected to a suspension connecting portion 73 provided at an outer end portion of the tubular member 55 in the vehicle width direction.

With this configuration, since both the rear suspension 32 and the rear frame 20 are attached to the tubular member 55 inserted into the seat frame 19 of the vehicle body frame 10 in the vehicle width direction, it is possible to attach the rear frame 20 and the rear suspension 32 to the vehicle body frame 10 with a small number of parts and with a simple structure.

The frame fixation portion 75 and the suspension connecting portion 73 are coaxial.

With this configuration, since the frame fixation portion 75 and the suspension connecting portion 73 are coaxial, it is easy to produce the tubular member 55.

The rear frame 20 includes a connection portion 20a that overlaps with the seat frame 19 from the inside in the vehicle width direction, and the connection portion 20a is fastened to the frame fixation portion 75 by the frame fastener 58 inserted into the connection portion 20a from the inside in the vehicle width direction.

With this configuration, since the connection portion 20a of the rear frame 20 and the frame fastener 58 can be hidden by the seat frame 19 from the outside in the vehicle width direction, it is possible to make the outer appearance simple and improve the outer appearance.

The connection portion 20a is fastened to the seat frame 19 at a position different from the position of the frame fastener 58 by a fastener 59 inserted into the connection portion 20a from the inside in the vehicle width direction.

With this configuration, it is possible to firmly fix the rear frame 20 by using the fastener 59 and to make the fastener 59 less conspicuous.

The rear suspension 32 fits to an outer peripheral portion 73c of the suspension connecting portion 73 and is prevented from coming out in the vehicle width direction by a suspension fixing member 76 fastened to the suspension connecting portion 73 from the outside in the vehicle width direction.

With this configuration, it is possible to prevent the rear suspension 32 from coming out with a simple structure. In addition, since this configuration has the suspension fixing member 76 and the frame fastener 58 separately, it is possible to attach and detach the rear suspension 32 and the rear frame 20 individually.

The seat frame 19 may include a tubular-member fixing hole 68 passing through the seat frame 19 in the vehicle width direction, the tubular member 55 may include an outer fitting portion 71 that fits into the tubular-member fixing hole 68 and an inner fitting portion 72 that fits into the tubular-member fixing hole 68 at a position on the inside of the outer fitting portion 71 in the vehicle width direction, an outer diameter of the outer fitting portion 71 may be larger than an outer diameter of the inner fitting portion 72, and the suspension connecting portion 73 may extend outward in the vehicle width direction from the outer fitting portion 71.

With this configuration, since as for the tubular member 55, the outer diameter of the outer fitting portion 71 provided on the rear suspension 32 side is larger than the outer diameter of the inner fitting portion 72, it is possible to receive the load of the rear suspension 32 efficiently via the outer fitting portion 71.

The seat frame 19 includes an outer side wall 65 that faces the rear suspension 32 and an inner side wall 66 that is away inward in the vehicle width direction from the outer side wall 65 and is formed to be hollow, and the outer fitting portion 71 fits into the tubular-member fixing hole 68 of the outer side wall 65, and the inner fitting portion 72 fits into the tubular-member fixing hole 68 of the inner side wall 66.

With this configuration, it is possible to reduce the weight by making the seat frame 19 hollow. In addition, it is possible to support the tubular member 55 effectively with the outer side wall 65 and the inner side wall 66.

The frame fastener 58 is inserted into the rear frame 20 from an inside in the vehicle width direction, the rear suspension 32 fits to an outer peripheral portion 73c of the suspension connecting portion 73 and is prevented from coming out in the vehicle width direction by a suspension fixing member 76 fastened to the suspension connecting portion 73 from the outside in the vehicle width direction, the seat frame 19 includes a tubular-member fixing hole 68 passing through the seat frame 19 in the vehicle width direction, the tubular member 55 includes an outer fitting portion 71 that fits into the tubular-member fixing hole 68 and an inner fitting portion 72 that fits into the tubular-member fixing hole 68 at a position on the inside of the outer fitting portion 71 in the vehicle width direction, an outer diameter of the outer fitting portion 71 is larger than an outer diameter of the inner fitting portion 72, the suspension connecting portion 73 extends outward in the vehicle width direction from the outer fitting portion 71, an inner end portion 76c of the suspension fixing member 76 in the vehicle width direction is located on the outside of the outer fitting portion 71 in the vehicle width direction, and an outer end portion 58a in the vehicle width direction of the frame fastener 58 fastened to the frame fixation portion 75 is located inside the tubular-member fixing hole 68.

With this configuration, since the outer end portion 58a of the frame fastener 58 in the vehicle width direction gets into the inside of the tubular-member fixing hole 68, the portion located inside the tubular-member fixing hole 68 in the frame fixation portion 75 of the tubular member 55 is solid because it is filled with the frame fastener 58. Thus, even in the case in which the outer diameter of the inner fitting portion 72 is small, it is possible to achieve enough stiffness of the inner fitting portion 72.

In addition, the inner end portion 76c of the suspension fixing member 76 in the vehicle width direction is located on the outside of the outer fitting portion 71 in the vehicle width direction, and the suspension fixing member 76 is relatively short. Thus, it is possible to reduce the weight of the suspension fixing member 76. In addition, since the outer fitting portion 71 has a larger diameter than the inner fitting portion 72, it is possible to achieve enough stiffness of the outer fitting portion 71.

Note that the above embodiment is for describing an aspect to which the present invention is applied, and thus, the present invention is not limited to the above embodiment.

Although the above embodiment has been described based on an example of the motorcycle 1, the present invention is not limited to this example, but the present invention is applicable to a three-wheeled vehicle with two front wheels or two rear wheels and a saddle-ride type vehicle with four or more wheels.

### REFERENCE SIGNS LIST

1 motorcycle (saddle-ride type vehicle)
10 vehicle body frame
19 seat frame (frame portion)
20 rear frame
20a connection portion
32 rear suspension
55 tubular member
58 frame fastener
58a end portion (outer end portion of the frame fastener in the vehicle width direction)
59 fastener
65 outer side wall
66 inner side wall
68 tubular-member fixing hole
71 outer fitting portion
72 inner fitting portion
73 suspension connecting portion
73c outer peripheral portion
75 frame fixation portion
76 suspension fixing member
76c end portion (inner end portion of the suspension fixing member in the vehicle width direction)

1. A saddle-ride type vehicle comprising:
a rear frame fastened to a frame portion that is a rear portion of a vehicle body; and
a rear suspension disposed at a rear portion of the vehicle body frame, wherein
the vehicle body frame includes a tubular member inserted into the frame portion in a vehicle width direction and fixed to the frame portion,
the rear frame is fastened by a frame fastener to a frame fixation portion provided at an inner end portion of the tubular member in the vehicle width direction, and
the rear suspension is connected to a suspension connecting portion provided at an outer end portion of the tubular member in the vehicle width direction.

2. The saddle-ride type vehicle according to claim 1, wherein
the frame fixation portion and the suspension connecting portion are coaxial.

3. The saddle-ride type vehicle according to claim 1, wherein
the rear frame includes a connection portion that overlaps with the frame portion from an inside in the vehicle width direction, and
the connection portion is fastened to the frame fixation portion by the frame fastener inserted into the connection portion from the inside in the vehicle width direction.

4. The saddle-ride type vehicle according to claim 3, wherein
the connection portion is fastened to the frame portion at a position different from a position of the frame fastener by a fastener inserted into the connection portion from the inside in the vehicle width direction.

5. The saddle-ride type vehicle according to claim 1, wherein
the rear suspension fits to an outer peripheral portion of the suspension connecting portion and is prevented from coming out in the vehicle width direction by a suspension fixing member fastened to the suspension connecting portion from an outside in the vehicle width direction.

6. The saddle-ride type vehicle according to claim 1, wherein
the frame portion includes a tubular-member fixing hole passing through the frame portion in the vehicle width direction,
the tubular member includes an outer fitting portion that fits into the tubular-member fixing hole and an inner fitting portion that fits into the tubular-member fixing hole at a position on an inside of the outer fitting portion in the vehicle width direction,
an outer diameter of the outer fitting portion is larger than an outer diameter of the inner fitting portion, and
the suspension connecting portion extends outward in the vehicle width direction from the outer fitting portion.

7. The saddle-ride type vehicle according to claim 6, wherein
the frame portion includes an outer side wall that faces the rear suspension and an inner side wall that is away inward in the vehicle width direction from the outer side wall and is formed to be hollow, and
the outer fitting portion fits into the tubular-member fixing hole hole of the outer side wall, and the inner fitting portion fits into the tubular-member fixing hole of the inner side wall.

8. The saddle-ride type vehicle according to claim 1, wherein
the frame fastener is inserted into the rear frame from an inside in the vehicle width direction,
the rear suspension fits to an outer peripheral portion of the suspension connecting portion and is prevented from coming out in the vehicle width direction by a suspension fixing member fastened to the suspension connecting portion from an outside in the vehicle width direction,
the frame portion includes a tubular-member fixing hole passing through the frame portion in the vehicle width direction,
the tubular member includes an outer fitting portion that fits into the tubular-member fixing hole and an inner fitting portion that fits into the tubular-member fixing hole at a position on an inside of the outer fitting portion in the vehicle width direction,
an outer diameter of the outer fitting portion is larger than an outer diameter of the inner fitting portion,
the suspension connecting portion extends outward in the vehicle width direction from the outer fitting portion,
an inner end portion of the suspension fixing member in the vehicle width direction is located on an outside of the outer fitting portion in the vehicle width direction, and
an outer end portion in the vehicle width direction of the frame fastener fastened to the frame fixation portion is located inside the tubular-member fixing hole.
